(19) United States
(12) Patent Application Publication
(10) Pub. No.: US 2025/0148313 A1
(43) Pub. Date: May 8, 2025

(54) MODIFYING RULE SYSTEMS

(71) Applicant: Hewlett-Packard Development Company, L.P., Spring, TX (US)

(72) Inventors: Daniel Cameron Ellam, Bristol (GB); Adrian John Baldwin, Bristol (GB)

(73) Assignee: Hewlett-Packard Development Company, L.P., Spring, TX (US)

(21) Appl. No.: 18/725,933

(22) PCT Filed: Jan. 11, 2022
(86) PCT No.: PCT/US2022/011928

§ 371 Date: Jul. 1, 2024

(51) Int. Cl. G06N 5/025

(52) U.S. Cl. CPC G06N 5/025

(57) ABSTRACT

In an example, a method is described. The method comprises receiving an indication of a change to a computing system useable in a computing network. The method further comprises establishing whether a rule system is affected by the change. In response to establishing that the rule system is affected by the change, the method causes the rule system to be modified to account for the change.

### BACKGROUND

A computing system may produce data responsive to events that occur as part of activities within the computing system. Analytic techniques may be used to analyze the behavior of the computing system based on the produced data.

### BRIEF DESCRIPTION OF DRAWINGS

Non-limiting examples will now be described with reference to the accompanying drawings, in which:

FIG. 1 depicts a flowchart of an example method of modifying a rule system;

FIG. 2 is a simplified schematic drawing of an example architecture for modifying a rule system;

FIG. 3 depicts a flowchart of an example workflow for modifying a rule system;

FIG. 4 depicts a flowchart of an example method of using a rule system;

FIG. 5 depicts a flowchart of an example method of modifying a rule system;

FIG. 6 depicts a flowchart of an example method of modifying a rule system;

FIG. 7 depicts a flowchart of an example method of modifying a rule system;

FIG. 8 schematically illustrates an example machine-readable medium for modifying a rule system;

FIG. 9 is a simplified schematic drawing of an example apparatus for use in indicating a change;

FIG. 10 schematically illustrates an example machine-readable medium for implementing various examples; and

FIG. 11 is a simplified schematic drawing of an example apparatus for implementing various examples.

### DETAILED DESCRIPTION

A computing system (e.g., implemented by a personal computer, laptop, tablet, phone, embedded system, Internet of Things (IoT) device, printer, etc.) may generate: information regarding events that occur in the computing system; information about the computing system itself and/or information about another computer system communicatively coupled to the information-generating computing system (e.g., within a computing network comprising the communicatively coupled computing systems). In an example, such information may be generated as part of, or in response to, activities that occur within the computing system and/or within the computing network (e.g., where an activity may be associated with at least one event that occurs as part of the activity).

Examples of activities that may occur during use of the computing system and/or computing network include: system booting, user log-in/log-out requests, software updates, admin-controlled changes, connecting to/disconnecting from networks, opening/running/closing of applications, connecting/disconnecting peripherals, adding/removing a computing system to/from the computing network, modifying a computing system in some way (e.g., modifying its hardware, software and/or firmware) prior to deployment and/or while the computing system is deployed in the computing network, etc.

The types of activities that occur may depend on the type of computing system. For example, a computing system such as a personal computer or laptop may have a broad range of functionality with multiple possible activities that may occur during use of the personal computer/laptop (e.g., including the example activities listed above) while a computing system such as an embedded system may have a comparatively restricted range of activities (e.g., related to the intended function of the embedded system itself) that may occur during use of the embedded system.

In some examples, the computing system may produce or collect a log (such as a record, system log or ‘syslog’, etc.) comprising ‘event information’. Such event information may be indicative of an activity in the computing network (e.g., within the computing system itself or of another computing system in the computing network). In some examples, the log may comprise information about an event (e.g., an event code, event description or some other indication of the type of event, a time of the event, etc.) associated with the activity. Activity information may be derived, by an analytical tool, from the log or a set of logs generated by computing system(s) in the computing network.

In some examples, the ‘activity information’ may comprise statistical information about what is happening in the computing network. In some examples, the ‘activity information’ may comprise data such as a count of events or other metrics representative of the activity or activities that have occurred. The format of the activity information may be such that it can be understood by the entity receiving the activity information (such as an admin or other operative). The generation of activity information may depend on a set of (predefined) rules implemented by the analytical tool. A rule may be triggered in response to activity in the computing network (as indicated to the analytical tool by the log or a set of the logs). In an example, certain activity may be observed in the computing network. If this activity triggers the rule (which may be triggered by, for example, a certain number of occurrences of a certain type of event, a certain percentage of occurrences of such events, etc.), information about this activity (i.e., the ‘activity information’ such as the number of occurrences, percentage of occurrences, etc.) may be generated by the analytical tool. For example, where a rule implemented by the analytical tool is triggered by activity in the computing network, the output of the ‘activity information’ resulting from the triggering of the rule may correspond to the information needed by the receiving entity (such as the admin or other operative that made the predefined rule) in order to take appropriate action in response to the analysis of the activity in the computing network.

In an example, the activity information may be produced as part of, or in response to, an activity that occurs within the computing system and/or computing network where that activity may trigger a rule to provide such activity information. In an example, a log may be produced as part of, or in response to, a single event that occurs as part of a single activity within the computing system and/or computing network. In another example, multiple logs may be produced as part of, or in response to, corresponding multiple events that occur as part of a single activity within the computing system and/or computing network. Thus, the log(s) may be indicative of the activity and the ‘activity information’ derived from the log(s) may represent the activity in some way such as via a metric or statistical information.

In some examples, the log may comprise ‘identifying information’ associated with the computing system that generates or collects the log and/or ‘identifying information’ associated with the computing system associated with the activity in the computing network. For example, the identifying information may identify a user and/or a component of the computing system itself (e.g., by using a user identifier and/or a component identifier).

In some examples, the computing system may collect or generate activity information in respect of a log based on an event that occurs within the computing system or elsewhere within the computing network. In an example, the computing system comprises a web client to facilitate user interaction with a web-based service. The computing system may collect information about the user's activity and produce a log comprising event information. In another example, the computing system comprises an embedded system (e.g., of a printer or Internet of Things (IoT) device, etc.) which produces logs in response to execution of code by the embedded system (e.g., due to events that occur on the embedded system). In some examples, the computing system may collect or generate information for a log based on an event that occurs upstream of the computing system (e.g., in another computing system of the computing network).

In some examples, a computing system may comprise processing circuitry (e.g., comprising a processor) for executing instructions for implementing certain functionality. For example, a computing system may implement functionality such as executing a subroutine as part of an event that occurs within the computing system, producing a log (e.g., in response to executing the subroutine or in response to receiving information from the computing system indicative of an event that occurs in the computing system itself or another computing system in the computing network), sending a log to/collecting a log from another computing system in the computing network, etc.

A set of logs may be collectively indicative of certain information about the computing system and/or computing network such as the performance of the computing system/computing network, end-user behavior, suspicious activity, etc. In some examples involving collecting of logs, such logs may be collected directly from computing systems or from a networked collector node, for example, a cloud or syslog server associated with the computing network.

Data analytics may be implemented to produce alerts, metrics and/or statistics (i.e., ‘output’) based on the set of logs. This output may be reviewed, for example by a human expert, machine operative or an artificial intelligence-based operative, to determine whether or not the computing system and/or the computing network as a whole is behaving as expected.

Data analytics may refer to a range of data processing techniques and may include machine learning-based techniques. The data analytics may be of varying complexity and may contain various configurable thresholds and parameter choices to filter and manipulate the input data (e.g., logs) to produce output (e.g., an inference about a computing system and/or associated computing network). Adjusting these choices may result in different analytic output. Some analytical tools may filter and/or aggregate the data collected from a computing system of the computing network.

Techniques for data analysis such as rules, analytics, and machine learning may involve processing input data to produce an output. For example, an analytical tool may operate by receiving input data such as a log as described above, processing the data, and producing an output depending on the rules of the processing. The output may comprise raw data, selected items of information derived from the log(s), a summary of received/processed data and/or metrics/statistics relating to the received/processed data.

In some examples, the data analysis may use codified or learnt logic about what the data points represent, and as such depend on a mapping of the data points to an interpretation. For example, such logic may interpret that a particular event code represents a failed user login.

Enterprise information technology and security administrators (e.g., ‘admin’ and/or an ‘analytics service’) may actively track activity of a computing network in an attempt to spot anomalous activity within the computing network.

### Modifying Rule Systems

A log generated or collected by a computing system in response to an event that occurs on the computing system or within the computing network may comprise information about the event that triggered generation of the log. The content of the log depends on, for example, the version of the firmware operated by the computing system. Other factors may affect the content of the log such as the hardware component(s) and/or software version present (associated with the computing system) at the time of log generation or collection.

Where a change occurs to a computing system useable in a computing network (e.g., a change such as a modification of the hardware, software and/or firmware of the computing system), a content of a log generated or collected by the computing system itself (or another computing system in the computing network) may also change. In an example scenario, a computing system may be modified while it is deployed in the computing network (e.g., as part of an admin-controlled software update). In another example, a computing system may be modified prior to deployment and then added to the computing network. In another example, a computing system may be removed from the computing network. In any of these cases, the types of logs generated or collected from the computing network may depend on which versions of the computing systems are deployed. For example, older/out-of-date computing systems may produce logs with certain content (e.g., ‘event information’) while newer/updated computing systems may produce logs with different content.

In some examples, the events that may occur during use of the computing network may depend on the versions/types of computing systems deployed. For example, certain versions/types of computing systems may not have certain functionality (such as a security function) whereas other versions/types of computing systems may have such functionality. In the example where the functionality is a security function, if the security function is actuated during use of the computing system, the logs generated/collected by the various versions of the computing systems may vary in terms of their content. In some examples, a log may not be generated at all (e.g., if the associated activity is not available with a certain version/type of computing system).

As a result of the potentially varying content of logs generated or collected from a computing network, the interpretation of the recorded activities may be a function of the version/type of computing systems within the computing network. For example, the mapping of event data to its interpretation can change if the computing system generating the data is updated in such a way that new events are generated or the conditions under which an event is generated changes, etc. For example, a computing system running an application may be updated with new configuration options and new system logging may be produced when these configuration options are changed.

In some examples, computing systems in a computing network (such as a fleet of printers within a computing network managed by an admin) may be updated at staggered times by the admin. Such updates may result in changes to the content of the generated logs.

An analytical tool (e.g., implemented or provided by an analytics service) may have an established set of rules, as part of a “rule system”, for alerting an admin to certain patterns of events in the computing network. However, these rules may become irrelevant or not function properly in view of the state of the computing network as updates are rolled out (or other changes are made) over time. For example, where a change is made to a computing system useable in the computing network, this may result in different logs being observed in response to activity in the computing network. Consequently, the analytical tool may behave differently. For example, a rule specified by the analytical tool may or may not be triggered in response to a set of logs generated as a result of activity in the computing network.

In an example scenario, an analytical tool may receive input data from a data generation process. The data output from the data generation process may change due to new release cycles of hardware, firmware and/or software. Within an enterprise, it may be possible to have a fleet with different versions of software etc., as rollout of updates and retirement of old software, firmware and/or hardware may occur at various/staggered times. This scenario may present a practical problem as the analytical tool may receive input data that changes over time due to this evolving data generation process. Consequently, the output of the data analytical tool may vary as a result of such changes.

There may be circumstances where a data analytics suite comprises tens or even hundreds of individual rules (as examples of ‘analytics’) to cover the breadth of possible scenarios. Small updates to the data generation processes may change the input data, and this may affect a large number of the analytics, which takes time and effort to update. Such updates to a computing system may be deployed in an aligned manner with updates to the data analytics suite if there is a good alignment between the development teams behind the applications and the data analytics to know about such changes. However, there may be cases where the different teams are decoupled from each other in terms of understanding what changes have been made within the computing network.

Irrespective of the time needed to update multiple analytics in response to changes in the computing network, if changes are not tracked and implemented, this may cause a period of false negatives, false positives and/or gaps in rule coverage, etc.

For example, suppose there exists an event code ‘ab.cd’ signifying that a failed login has occurred. If an application run by a computing system is updated to allow logins to occur via an alternative method, e.g., single sign-on (SSO), a new event code may be created to reflect successful and failed logins via this method, e.g., ‘ab.ce’. An analytical tool relating to or using information about failed logins may need updating to incorporate such new events. As highlighted above, the analytical tool may not actually be updated in a timely manner, resulting in inaccurate or misleading output from the analytical tool.

In another example, a certain event code may become obsolete if no corresponding events occur after a firmware update is deployed to a computing system. A rule written based on an expectation that the event code may continue to be observed to the same extent after the update has been deployed may not accurately represent activity in the computing network. In another example, a different login procedure may be implemented by an update and the analytical tool may need to be updated to understand new event codes generated as a result of the different login procedure.

Examples described below may update a rule system implemented by an analytical tool in response to changes made to a computing system usable in a computing network. For example, by using an information flow which includes knowledge about the creation of new events (that may occur after an update has been rolled out), certain examples described herein may automatically update the rule system and/or create suggested new rules for use in the rule system.

FIG. 1 depicts a flowchart of an example method 100 of modifying a rule system. The method 100 may be a computer-implemented method. The method 100 may be implemented by processing circuitry (e.g., comprising a processor) associated with an entity for managing/controlling the rule system used for producing the output of an analytical tool. As described in more detail below, the method 100 may be implemented by an admin of an enterprise (such as where the admin is involved in running a data analytics suite), a service provider (such as a provider of a service that runs the data analytics suite for the customer). In either case, the entity may have knowledge or access to knowledge about what changes are due to be made or have been made to the computing system/computing network.

As highlighted above, the deployment of the software, hardware and/or firmware updates may be decoupled from the update to the data analytics. Thus, the entity that implements the method 100 may depend on the model used by the enterprise associated with the computing network. For example, larger enterprises may handle analytics in-house whereas smaller enterprises may outsource the analytics function to a service provider.

The method 100 comprises, at block 102, receiving an indication of a change to a computing system useable in a computing network.

The indication of the change may be provided in a format understandable to the entity implementing the method 100. For example, the indication of the change may comprise structured data/file in a format such as JavaScript Object Notation (JSON). In some examples, the indication of the change may be provided via an ‘event change log’ such as described below.

In some examples, the indication of the change may be received from the computing system itself or another computing system associated with the computing network. In some examples, the indication of the change may be stored in a memory device accessible to the entity implementing the method 100. For example, a database stored in the memory device may be used to store information about the changes that have been made or due to be made to the computing system and/or the computing network.

Some examples of the types of change that may occur are described below.

The method 100 further comprises, at block 104, establishing whether a rule system is affected by the change. The rule system is used to provide activity information indicative of an activity in the computing network. A rule of the rule system is applied to provide the activity information in response to identification of an event in the computing network that triggers implementation of the rule to provide the activity information.

For example, the method 100 may involve establishing whether the rule system is affected by the change e.g., by checking whether any of the existing rules implemented by the rule system can be mapped to/associated with an event associated with the change. If the rule system seems to already cover the event, then no further action may be needed. However, if the rule system does not seem to cover the event (e.g., the indication of the change comprised a new event or a modified event or some other information relevant to the rule system), some action may be taken as described below. In some examples, the “identification of the event in the computing network that triggers implementation of the rule” may be implemented by the analytical tool. For example, the analytical tool may identify/receive a log representative of the event (that is to trigger implementation of the rule). Thus, the analytical tool may provide the activity information due to receipt of the log that triggers the implementation of the rule. In an example, the receipt of the log may be such that a threshold specified by the rule is crossed (e.g., the threshold may be a specified number/percentage of specified events within a specified timeframe, etc.), which then causes the activity information to be provided in response to identification of the event that triggered implementation of the rule (e.g., due to receipt of the log).

In response to establishing that the rule system is affected by the change, the method 100 further comprises, at block 106, causing the rule system to be modified to account for the change.

Thus, the rule system may be modified (e.g., automatically) in response to changes that occur in the computing network. Since the events that are generated may change over time as a result of a change to a computing system useable in the computing network (e.g., prior to or during use in the computing network), this modification may reduce the burden placed on an entity running an analytics service, thus reducing running costs and/or reducing the chance of errors as new events are observed, old events are no longer observed and/or any different behavior that occurs in the computing network as a result of the change.

In some examples, logic associated with executing the method 100 may automatically add a rule to, remove a rule from or replace/modify an existing rule in the rule system based on the received indication. In some examples, the logic may access and use a rule template to generate suggested new rules based on the received indication.

In an example implementation, an indication such as an ‘event change log’ may be generated by a computing system in response to an update applied to the computing system (or it may be generated by another entity with knowledge of the update). The indication/event change log may be analyzed to determine whether the rule system needs to change. If so, an existing rule may be modified to account for the change or a new rule may be created from a template.

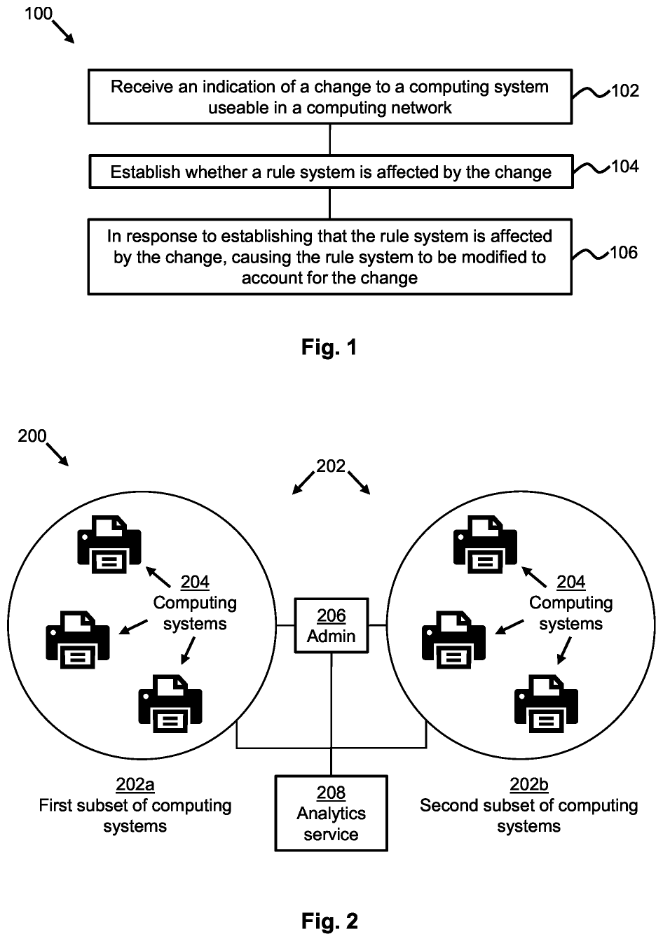

FIG. 2 depicts an example architecture 200 for modifying a rule system in accordance with the method 100 and/or other examples described herein.

The architecture 200 comprises a set 202 of computing systems 204 (which may represent a ‘computing network’ comprising the set 202 of computing systems 204). The set 202 comprises a first subset 202a of the computing systems 204 and a second subset 202b of the computing systems 204. In an example, the computing systems 204 of the first subset 202a may operate under a first version of firmware while the computing systems 204 of the second subset 202b may operate under a second version of firmware. The different versions being operated at the same time may be the result of an admin 206 of the architecture 200 rolling out an update to one of the subsets 202a, 202b but not the other of the subsets 202b, 202a.

In use of the architecture 200, logs may be generated by the computing systems 204 in response to events that occur on the computing systems 204 (such as log in events, etc.). These logs may be received by the analytics service 208, which may process the received logs according to its ‘rule system’ to identify/highlight a certain pattern of behavior in the computing network. In some examples, a rule of the rule system may be triggered in response to a certain pattern of behavior such as a threshold number of unsuccessful login attempts being detected within a specified timeframe. The analytics service 208 may output an alert about this detected behavior. In some examples, the alert may comprise raw data (e.g., derived from the received logs), statistical information about what behavior has been detected in the computing network and/or a description or other indicator about the behavior in the computing network. In response, the admin 206 may be alerted so that they can take appropriate action.

Since a change may be made to a computing system 204 useable in the computing network (e.g., prior to or during deployment in the computing network), the logs received by the analytics service 208 may vary over time as a result of this change. There may be scenarios where such a change may lead to the need to modify the rule system implemented by the analytics service 208. The modification of the rule system may need to happen in response to a single change or may need to happen in response to multiple changes (e.g., rolling out an update to multiple computing systems 204).

The depicted architecture 200 may take any appropriate form, for example, according to the structure of the computing network and/or the model used for providing the analytics service.

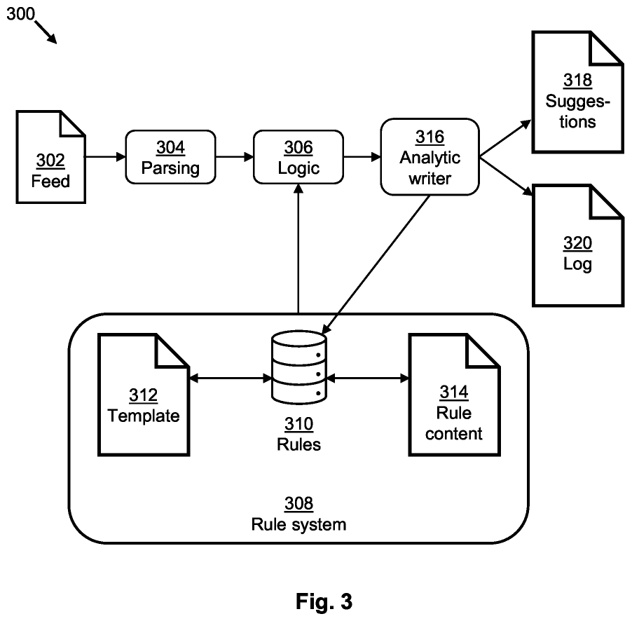

FIG. 3 depicts a flowchart of an example workflow 300 for modifying a rule system. The workflow 300 may implement various examples described herein such as the method 100 and other methods, machine-readable media and apparatus described herein. In some examples, the workflow 300 may be implemented by an analytical tool such as provided by the analytics service 208 of FIG. 2. In some examples, a different entity such as the admin 206 may implement certain functionality of the workflow 300. A description of the example workflow 300 is now given. Certain blocks of the workflow 300 may be omitted or performed in a different order to that depicted by FIG. 3, for example, depending on the architecture 200 and/or the content of the ‘indication of a change to a computing system useable in a computing network’.

Feed data 302 such as an ‘event change log’ (an example of which is given below) is received by the analytical tool. The feed data 302 is an example of an ‘indication of a change to a computing system useable in a computing network’ referred to in the method 100. In some examples, such feed data 302 may be received in response to events such as the rollout of an update. In some examples, such feed data 302 may be accessible to the entity implementing the workflow 300 (e.g., via a memory device (not shown) storing previously-obtained feed data 302). In some examples, the feed data 302 may comprise a structured file/data comprising an indication of the change.

At block 304 of the workflow 300, a parsing operation may be performed to identify and extract information from the feed data 302. For example, if the feed data 302 is in a structured format, the parsing operation at block 304 may facilitate distinguishing between different parts of the feed data 302 (e.g., distinguishing events, event codes and other information, etc.).

At block 306 of the workflow 300, a logic operation may be performed with respect to the parsed data provided as a result of the parsing operation. The logic operation at block 306 may establish whether a rule system 308 implemented by an analytic tool is affected by the change (e.g., in accordance with block 104 of the method 100). The rule system 308 is accessible to processing circuitry for implementing the logic operation/analytical tool (e.g., the same processing circuitry for implementing the method 100 and other examples described herein).

In this example, the rule system 308 comprises a set of rules 310 (e.g., a database of rules 310), a (rule) template 312 and rule content 314. These components of the rule system 308 are described in more detail below.

In an example, the processing circuitry associated with the analytical tool may review the feed data 302 directly (or review the output of a parser for implementing block 304) and interpret what updates (if any) are needed to be made to the analytics (i.e., the rule system 308).

At block 316 of the workflow 300, an analytic writer implements the changes by updating the rule system 308 (e.g., by adding new entries to, removing entries from and/or modifying entries in the set of rules 310 and/or rule content 314) based on the updates identified by the logic operation at block 306. In some examples, the changes may be implemented automatically. In some examples, the analytic writer may output a suggested change (i.e., a suggestion 318 file/data) as a result of identifying a change that may have a consequence to a rule of the set of rules 310 and/or rule content 314 of the rule system 308. In some examples, such output may be implemented by a human expert or a computer-based operative such as an artificial intelligence (AI) engine. In some examples, a log 320 representative of the change may be output by the ‘analytic writer’ at block 316 (e.g., so that any applied changes can be evaluated by a human expert or computer-based operative).

Some details of how events may change over time are given in the description below.

A change made to a computing system may result in corresponding change in an observed event. This change to the event may be represented in various ways. For example, a brand-new event may occur as a result of the change, which may be reflected by a new log (with a different header and/or content) being generated as a result. However, some changes may result in a different header and/or content in a log.

When referring to a change to an ‘event’ itself, this may refer to a change to an item such as a log, syslog event, Hypertext Transfer Protocol (HTTP) header, etc. In some examples, a change to an ‘event’ itself may refer to a change to a ‘type’ of the event (e.g., a log may be generated under different circumstances or when different a different condition is met). In some examples, a change to an ‘event’ itself may be represented by ‘an event identifier’ for identifying the event (e.g., to distinguish the event from other events). In some examples, a change to an event may be represented by a change type indicative of whether the indication relates to the new or existing event.

When referring to a change to an item such as an ‘event feature’, this may refer to a change to a log such as a change of ‘attribute’ such as timestamp field, status code field, etc. In some examples, an ‘event feature’ may be indicative of an attribute of the event.

When referring to a change to an item such as an ‘event feature value’, this may refer to a change to a log such as a change of login type value, a status code such as ‘200’, etc. In some examples, an ‘event feature value’ may be associated with the event feature, for example, where the event feature value is indicative of an attribute value. In relation to the above example, an event feature may refer to an attribute such as time (e.g., represented by a field of the log), while the event feature value may refer to an attribute value such as a timestamp entered into the field.

Some events may not be associated with all possible attributes (such as an event code in the form ‘ab.cd.ef’). For example, some attributes may not be relevant to a change or the change may be in respect of a different attribute of a log. An example printer syslog event is ‘<device type>: Jetdirect logging started; time=“<timestamp>” outcome=success’. In this example, the ‘event’ is the full event, an ‘event feature’ could be the ‘outcome’ attribute and an event feature value for the event feature ‘outcome’ could be ‘success’.

There may be various ways in which events may change as a result of the change to the computing system.

In some examples, a new event may be created as a result of the change.

In some examples, an existing event may be removed or may obsolete, with no replacement.

In some examples, an old event may be replaced directly by a new event, where the meaning of the event is kept the same, i.e., a ‘1-to-1’ relationship between the old and new event.

In some examples, an old event may be divided into several new events, i.e., a ‘1-to-many’ relationship between the old event and the new events.

In some examples, an event may represent a selected combination or ‘composite’ of any of these examples. For example, if an event code is repurposed for an entirely different function, then this may be regarded as a combination of a creation of a new event in response to removal of an existing event.

Where there are multiple versions of hardware, firmware and/or software in a computing network, different events may be generated by as a result of the multiple versions. The logic operation at block 306 may need to account for these different versions so that old and new events can be recognized and interpreted accordingly.

As noted above, the ‘indication’ may comprise an ‘event change log’. An event change log may be generated in response to knowledge that a change has been made. In some examples, the event change log may be generated by the computing system that has undergone the change. In some examples, the event change log may be generated by another entity such as the admin 206 with knowledge of the change.

The event change log may be structured in such a way that the information on updates to the input data are conveyed in a readable format (e.g., to facilitate extraction of the relevant information). In some examples, the event change log may comprise a list of enrichment data (“enrich”) pertaining to the event, such as whether it is a security event. Such enrichment data may be used by the logic operation at block 306 in various ways, for example, to modify a template 312 to create a new or modified rule for the rule system 308.

The following is an example of an ‘event change log’ using JSON (although other formats are possible), for each of the potential changes listed above.

```
{
  ″updates″:[
    {″change_type″:{
      ″id″:1,
      ″name″:″New event creation″
      },
    ″event″:{
″_comment″: ″Indicates a new event feature value was added″,
      ″event″:″ev_i″,
      ″event_feature″:″F″
      “event_feature_value”:”V”
      },
    ″enrich″:[″login″]
    },
    {″change_type″:{
      ″id″:1,
      ″name″:″New event creation″
      },
″event″:{
″_comment″: ″Indicates a new event feature was added. The event feature
value list is optional″,
      ″event″:″ev_j″,
      ″event_feature″:″F2″
      “event_feature_value”:[”V1”, “V2”,...,”Vn”]
      },
    ″enrich″:[″login″]
    },
    {″change_type″:{
      ″id″:2,
      ″name″:″Event removal″
      },
    ″event″:{
      “_comment”:”Indicates event_feature_value V was removed”
″event″:″ev_i″,
      ″event_feature″:″F″
      “event_feature_value”:”V”
      },
    ″enrich″:[″login″, “Admin activity”]
    },
    {″change_type″:{
      ″id″:3,
      ″name″:″Event replacement″
      },
    ″event″:{
      “_comment”:”Event ev_i is replaced by ev_j”,
      ″old_event_id″:″ev_i″,
      ″new_event_id″:″ev_j″,
      },
    ″enrich″:[″admin config change″]
    }
    {″change_type″:{
      ″id″:4,
      ″name″:″Event division″
      },
    ″event″:{
      ″old_event_id″:″ev_i″,
      ″new_event_id″:[″ev_j1″,...,″ev_jn],
      },
    ″enrich″:[″admin config change″]
    }
  ]
}
```

As indicated by the above example of an event change log, there are four different change types with identifiers, IDs, from 1 to 4. Each change type is associated with an event name and has associated information relevant to the change type.

In the example of the ‘new event creation’, an event can be identified as “event”:“ev_i”, its attribute may be “event_feature”:“F” and the attribute value may be “event_feature_value”:“V”. The enriched data may be ‘login’. In some examples, an ‘optional’ list of information about the event may be provided. For example, an event identified as “event”:“ev_j”, an attribute “event_feature”:“F2” and corresponding attribute value “event_feature_value”:[“V1”, “V2”, . . . , “Vn”]. When a new event is created, the information about the event may be extracted from the above-indicated fields of the event change log.

In the example of the ‘event removal’, certain information relating to the event may be removed. For example, a certain event feature value may be removed since this is no longer observable.

In the example of the ‘event replacement’, a different event identifier, “ev_j” is used instead of the old identifier, “ev_i”.

In the example of the ‘event division’, multiple event identifiers, [“ev_j1”, . . . , “ev_jn] may be observed in place of the old event identifier, “ev_i”.

The above are given as examples and other changes at different levels (e.g., events themselves, event features and event feature values) may be made in respect of any of these examples.

The structured format of the event change log may facilitate extraction of the information relating to the change by the parsing operation at block 304, and so that the logic operation at block 306 may establish whether the rule system 308 needs to be changed as a result of the content in the event change log.

As noted above, the rule system 308 may be associated with rule content 314. The rule content 314 may represent a file or database about events and associated rules mapped to the event information that can be updated in response to the event change log.

In some examples, the rule content 314 may be populated manually by data analysts creating the rules, or automatically with a script. An example of an entry in the rule content 314 may be represented in the following manner: ‘rule_1:[(ev_1, [F1:[V11, V12, . . . , V1n], . . . , Fm:[Vm1, . . . , Vmn]]), . . . , (ev_a, [ . . . ])]’, where ‘ev_i’ is a distinct system log identifier, ‘Fi’ indicates an event feature, and ‘Vij’ indicates a feature value for feature Fi. This entry represents that there is a rule called rule_1 whose logic depends on system logs ev_1, . . . , ev, along with some set of features and feature values._a. Thus, whenever a change is made (e.g., to ev_i, Fi and/or Vij), the logic operation at block 306 may update rule_1 accordingly (e.g., by adding and/or removing information from the entry). In some examples, a brand-new rule may need to be created as a result of a change since the existing rules are not relevant or cannot be modified for some reason.

As noted above, the logic operation at block 306 may receive updates following the parsing operation at block 304. The logic operation at block 306 may then determine which of the set of rules 310 from the rule content 314 are affected by the update. In some examples, a state machine implemented by the logic operation at block 306 may then determines which of a number of possible actions need to occur, depending on the indicated change_type.

In the case of a change ‘type 1’ (i.e., a new event may be created), a template 312 may be used in the creation of the new rule to be implemented by the rule system 308, as described in more detail below.

In the case of a change ‘type 2’ (i.e., an existing event may be removed or made obsolete, with no replacement), it may take a while before an event can be removed. For example, it may take some time for a fleet of computing systems to be updated to the latest version of firmware, software etc., but once a determination has been made that the entire fleet has been updated, then rules with dependency on the removed event may be identified from the rule content 314 and marked for removal. In some examples, a new rule may be created to alert if the old event pattern is seen again, since this may indicate a firmware or software rollback or that there is still outdated firmware or software in deployment.

In an interim period when there is a mix of old and new firmware or software in deployment in a computing network, threshold numbers in the rules may be adjusted to reflect the changes in the number of devices running new and old firmware or software. By way of example, a rule may alert if ‘n’ failed logons are detected within an hour. However, if a certain percentage of the fleet is running new software to produce an event in the instance of a failed login, then a rule may be specified to scale ‘n’ in accordance with the specified percentage.

For example, in a fleet of 1000 computing systems where half are running the new software, and a rule associated with the new software alerts if 10 failed logons within the 1000 computing systems (i.e., 1%) are detected with an hour (e.g., where the original rule was designed by an expert as indicating a potentially concerning pattern of behavior), the rule may be modified such that it is triggered if 5 failed logons occur within an hour with respect to the 500 ‘new’ computing systems. The point is that 10 logons (i.e., 2%) may be too high a threshold and result in the rule being triggered too late in response to the anomalous pattern. Thus, the rule may be scaled (e.g., a ‘threshold’ for triggering the rule may be changed) to account for the number of the different versions of computing systems in the computing network.

In some examples, when it is appropriate to do so, the analytic writer at block 316 may remove the rule from the set of rules 310 automatically and log its actions via the log 320. In some examples, the analytic writer at block 316 may output a suggestion 318 on its proposed change (i.e., removal of an event) for action by a human expert or computer-based operative.

In the case of a change ‘type 3’ where an old event may be replaced directly by a new event, rules with dependency on the replaced event may identified by the logic operation at block 306 from the rule content 314. In some examples, the analytic writer at block 316 may update the rule identified in the set of rules 310 by automatically by replacing the ‘event_id’ and/or ‘event_features’ of new and old events within the rule content 314 and then log its actions via the log 320. In some examples, the analytic writer at block 316 may output a suggestion 318 on its proposed change (i.e., direct replacement of an event) for action by a human expert or computer-based operative.

As discussed above, there may be an interim period where both old and new firmware or software are present in the fleet. Change type 3 may also include the creation of composite rules, which use both the old rule and new rule in combination until the old firmware or software is finally removed from the fleet.

In the case of a change ‘type 4’ where an old event may be divided into several new events, rules with dependency on the event to be divided may be identified from the rule content 314. In some examples, the analytic writer at block 316 may remove the existing rule from the set of rules 310 automatically and log its actions via the log 320. A template 312 may then be used to create new rules from the division indicated by the event change log. The analytical writer at block 316 may map the new rules to the relevant parts of the rule content 314. In some examples, the analytic writer at block 316 may output a suggestion 318 on its proposed change (i.e., division of an event) for action by a human expert or computer-based operative.

In the case of a change ‘type 5’, a composite of change types 1 to 4 may be implemented in some scenarios.

Some change types refer to use of a template 312 to create a new rule.

For change_type cases 2 and 3, the logic operation at block 306 to update the rule system 308 may be relatively straightforward to implement (e.g., since they involve extraction of data from the event change log and then modifying existing rules and/or their associated content in some way).

However, in the change_type cases where a new event is added (i.e., types 1, 4 and sometimes 5), it may be useful to automate the creation of new rules and update existing ones to incorporate the creation of new events. A template 312 (e.g., from a database of templates such as designed by a human expert) may be used to help with the creation of new rules.

In some examples, templates represent generic data analytic logic, e.g., created by human experts, which can be instantiated with event data. A template may be a parametrizable rule indexed by identifiers for enrichment data. Given a piece of enrichment data, an event_id and possibly an event_feature and event_feature_value, the correct template may be retrieved using an enrichment data index, and the rule parameters filled in using, for example, the event_id, event_feature and/or event_feature_value, depending on the template's specification. This implementation may instantiate the template and create a rule based on the event_id, event_feature and/or event_feature_value.

Therefore, a template 312 may be modified with enrichment data when a new rule needs to be created in respect of a new event_id, event_feature and/or event_feature_value associated with a change to the computing system.

An example scenario may be where there is an existing template pertaining to admin configuration changes. This admin configuration change may relate to an administrator making a settings change with respect to a computing system. The settings change may relate to a security feature. The settings change turns off the security feature. However, there are no support tickets related to the settings change.

An example template 312 may be indexed with [“admin config change”, “security disabled”] as part of creation of the new rule. Such a template 312, when modified, may comprise the configuration change event, along with features indicating the configuration change that occurred.

In some examples, more detailed rule templates could refer to features within the event. For example, this may apply where an event involves an admin making settings changes where there is a correlation with a login source. There could be different rules for different sources (e.g., to detect that a certain admin is associated with the change). Adding a new possible source value may facilitate adaption/duplication of a rule to include the new login source.

In another example, a template 312 could be modified based on an event ‘Config_change <changedValue=<setting_1| . . . |setting_n> . . . ’. In this case, there may be rules triggering on particular settings. As new settings added, this could result in the creation of new rules for the given value.

In another example, where a new rule is created based on a template 312, the template may comprise the following content: ‘For Rules with tag_y, GenRule(<eventtype_i, . . . >)->Rule_for eventtypes I, . . . ’. Thus, as new event types are added (e.g., if an admin 206 changes a new security feature with a tag that says it relates to security), the rule may be generated based on the template 312 to provide a metric or other indication such as count occurrences or alert if the security feature is turned off.

In another example, a change to a computing system 204 may result in the computing system 204 indicating an event occurrence such as via a security ‘alert’, which could be a new behavior of the computing system caused by the change. However, the template 312 may specify ‘count occurrences’ (e.g., number of events in the computing network) as part of a rule. In some examples, the template 312 may be modified in terms of how a rule based on the template 312 is to account for the change, such as when the change leads to different needs (e.g., since ‘alerting’ is a different functionality to ‘counting’). An example of a ‘different need’ includes changing a threshold for alerting (e.g., in case the existing rule does not scale according to the number of computing systems in the computing network operating with a certain hardware, software and/or firmware version, as referred to in a previous example).

As highlighted above, there may be circumstances where there is more than one possible rule to use, depending on the events that may occur in the computing network (e.g., based on the deployed versions of the computing systems). In a computing network where multiple data generation processes may be present (e.g. from different software versions), the workflow 300 may create different rules for the different data generation versions (e.g. software versions, firmware versions, hardware installed, etc.). When analyzing the data provided in the event change log, the logic operation at block 306 may need to determine which rule version should be used for a given message. In some cases, this may be straightforward to implement such as if the logic operation at block 306 knows which computing system 204 an event originated from in combination with, for example, having access to information about the software, firmware and/or hardware version associated with the computing system (e.g., recorded in a data database such as the rule content 314). In some cases where this connection is not recorded or is not possible for some reason, the logic operation at block 306 may further study the event structure and the event feature values and compare against a library of event information (including versions) to decide which data generation version is most likely to have been responsible for the event, and therefore which rule is to be used. A default rule may be selected in the case that it cannot be decided which version was responsible for the event.

Some examples relating to the above are described below.

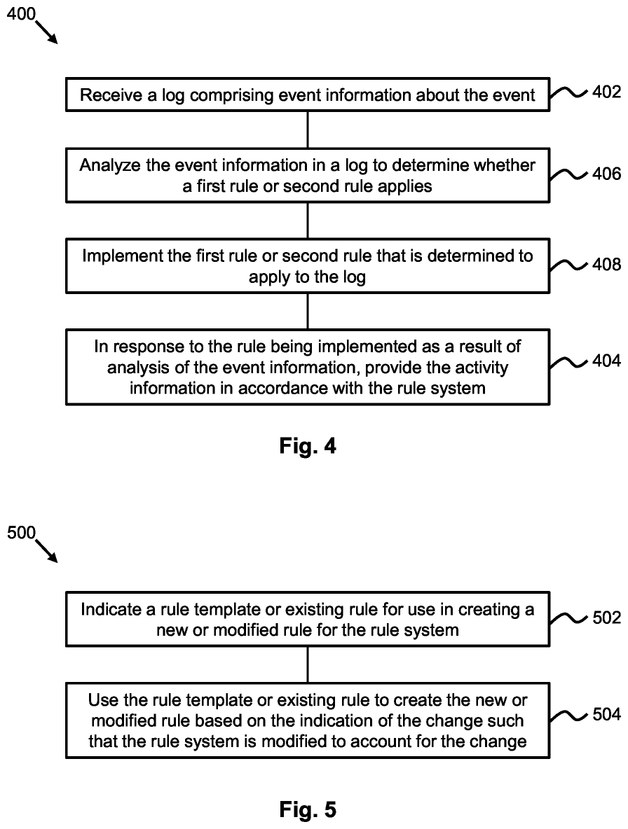

FIG. 4 depicts a flowchart of an example method 400 of using a rule system such as the rule system 308. In some examples, the method 400 may be implemented by the analytics service 208. Thus, the method 400 refers to use of the architecture 200 (e.g., use of the architecture 200 after its rule system 308 has been modified to account for any changes that have occurred). The method 400 may be implemented in conjunction with or as part of the method 100 or any other examples described herein. Certain blocks of the method 400 may be omitted, or performed in a different order to that depicted, in accordance with the examples described below and elsewhere herein.

In some examples, the method 400 comprises, at block 402, receiving a log comprising event information about the event. This log may, in some examples, be distinguished from the event change log described above. The event information in the log may be indicative of activity in the computing network and/or an event associated with the computing system 204.

In response to the rule being implemented as a result of analysis of the event information (e.g., derived from the received log), the method 400 comprises, at block 404, providing the activity information in accordance with the rule system 308. In some examples, the activity information may refer to a metric, statistical information or another representation about what is happening in the computing network so that appropriate action can be taken.

In some examples, the received log is generated by a computing system 204 (e.g., from the first subset 202a or second subset 202b). A first rule of the rule system 308 may apply to logs generated by a first version of the computing system 204. A second rule of the rule system 308 may apply to logs generated by a second version of the computing system 204. Thus, depending on whether the computing system is from the first subset 202a or second subset 202b, the rule system 308 may function differently (e.g., trigger a rule at a different threshold, produce output such as the ‘activity information’ or not produce such output, etc.) depending on which version the computing system 204 is operating. In certain examples where such first or second rules may apply, the method 400 further comprises, at block 406, analyzing the event information in the received log to determine whether the first rule or second rule applies. The method 400 further comprises, at block 408, implementing the first rule or second rule that is determined to apply to the log generated by the computing system.

In examples where it is established that the rule system 308 is affected by the change, a rule may be created or modified in accordance with the various examples already described in order to modify the rule system 308. Examples associated with these examples are now described.

FIG. 5 depicts a flowchart of an example method 500 of modifying a rule system such as the rule system 308. In some examples, the method 500 may be implemented by the analytics service 208, e.g., as part of the logic operation 306 represented by the workflow 300. The method 500 may be implemented in conjunction with or as part of the method 100 or any other examples described herein. Certain blocks of the method 500 may be omitted, or performed in a different order to that depicted, in accordance with the examples described below and elsewhere herein.

In response to establishing that the rule system 308 is affected by the change, the method 500 comprises, at block 502, indicating a rule template (e.g., from a database of rule templates 312) or existing rule (e.g., from the set of rules 310) for use in creating a new or modified rule for the rule system 308.

The method 500 further comprises, at block 504, using the rule template 312 or existing rule to create the new or modified rule based on the indication of the change such that the rule system 308 is modified to account for the change.

In some examples, using the rule template 312 or existing rule to create the new or modified rule based on the indication of the change such that the rule system 308 is modified to account for the change comprises at least one of the following actions.

In some examples, an action may comprise adding event information to the (indicated) rule template 312 about a new event associated with the change to create the new rule.

In some examples, an action may comprise modifying the rule template 312 to account for the change.

In some examples, an action may comprise modifying the existing rule by removing event information about an existing event specified by the existing rule.

In some examples, an action may comprise modifying the existing rule by replacing event information about an existing event specified by the existing rule with new information about the existing event.

In some examples, an action may comprise modifying the existing rule by dividing event information about an existing event specified by the existing rule into a plurality of parts of event information.

Any number or combination of the above actions may be implemented as part of creating the new rule or modifying the existing rule.

In some examples, the added, removed, replaced and/or divided event information about the new or existing event comprises certain information.

In some examples, the certain information may refer to a type of the new or existing event.

In some examples, the certain information may refer a change type indicative of whether the indication relates to the new or existing event.

In some examples, the certain information may refer to an event identifier for identifying the new or existing event.

In some examples, the certain information may refer to an event feature indicative of an attribute of the new or existing event.

In some examples, the certain information may refer to an event feature value associated with the event feature, where the event feature value is indicative of an attribute value.

In some examples, any number or combination of the above certain information may be related to the added, removed, replaced and/or divided event information

In some examples, causing the rule system 308 to be modified to account for the change comprises changing the activity information to be provided in response to the event based on the received indication. For example, the ‘output’ produced when a rule is triggered may be modified (e.g., in contrast to a modification that is implemented by changing event information such as stored in the rule content 314 of the rule system 308).

In some examples, the indication of the change comprises event change data (e.g., an event change log) produced by the computing system 204. However, in some examples, a different entity may provide the indication of the change e.g., if such an entity such as an admin 206 has knowledge about the change. In some examples, the event change data may be reported prior to deployment or during deployment of the computing system 204 in the computing network.

In some examples, the event change data is produced in response to a change in state of the computing system 204. For example, an inbuilt function of the computing system 204 may be to report event changes as a result of the change in state, or the change in state could, by itself, cause the event change data to be produced by the computing system 204.

In some examples, the change in state comprises execution of an update to a firmware or software operated by the computing system 204.

In some examples, the change in state comprises a change in hardware of the computing system 204. For example, a new type of hardware with similar messages (e.g., a computing system 204 such as an Internet of Things (IoT) device may be deployed with a different functionality but the same administrative interface and functionality as a presently deployed computing system 204).

In some examples, the change in hardware could be the result of any manual installation, replacement or removal of a hardware element associated with the computing system 204 (e.g., where such a change in hardware potentially has an implication on the rule system 308).

An example implementation of part of the workflow 300 is now described.

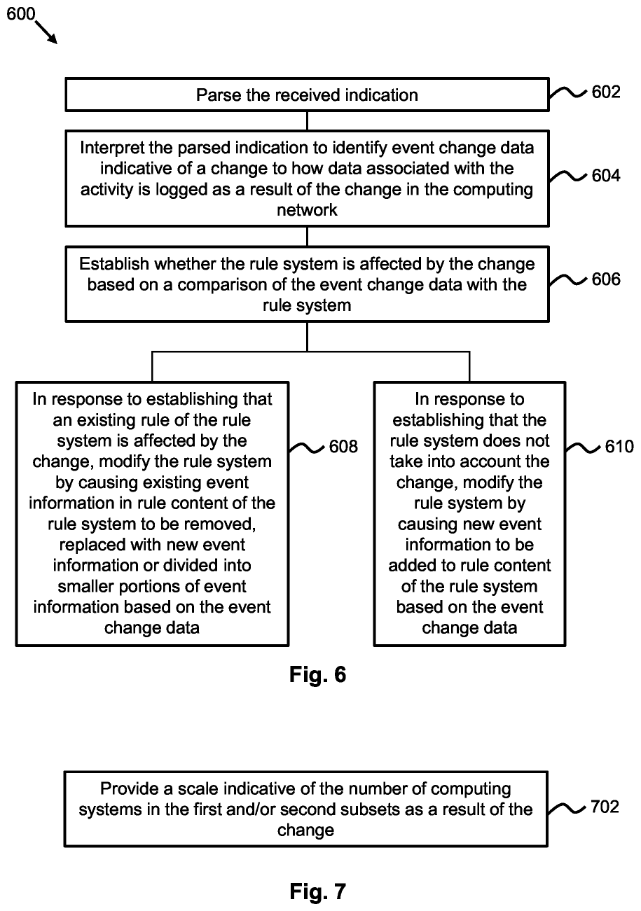

FIG. 6 depicts a flowchart of an example method 600 of modifying a rule system such as the rule system 308. In some examples, the method 600 may be implemented by the analytics service 208, e.g., as part of the logic operation 306 represented by the workflow 300. The method 600 may be implemented in conjunction with or as part of the method 100 or any other examples described herein. Certain blocks of the method 600 may be omitted, or performed in a different order to that depicted, in accordance with the examples described below and elsewhere herein.

The method 600 comprises, at block 602, parsing the received indication.

The method 600 further comprises, at block 604, interpreting the parsed indication to identify event change data indicative of a change to how data associated with the activity is logged as a result of the change in the computing network.

The method 600 further comprises, at block 606, establishing whether the rule system 308 is affected by the change based on a comparison of the event change data with the rule system 308.

In response to establishing that an existing rule of the rule system is affected by the change, the method 600 further comprises, at block 608, modifying the rule system 308 by causing existing event information in rule content of the rule system 308 to be removed, replaced with new event information or divided into smaller portions of event information based on the event change data.

In response to establishing that the rule system 308 does not take into account the change, the method 600 comprises, at block 610, modifying the rule system 308 by causing new event information to be added to rule content of the rule system 308 based on the event change data.

In examples where there is at least a first and second subset 202a, 202b of computing systems 204 implementing different versions, a rule may be updated or modified to account for the change e.g., to ensure that the output when the rule is triggered is representative of the state of the overall computing network. An example implementation of how this change is taken into account is provided below.

FIG. 7 depicts a flowchart of an example method 700 of modifying a rule system such as the rule system 308. In some examples, the method 700 may be implemented by the analytics service 208, e.g., as part of the logic operation 306 represented by the workflow 300. The method 700 may be implemented in conjunction with or as part of the method 100 or any other examples described herein.

Thus, where the computing network comprises a set 202 of computing systems 204 in which a first subset 202a of the set 202 of computing systems 204 comprises a first version of hardware, software and/or firmware and a second subset 202b of the set 202 of computing systems 204 comprises a second version of hardware, software and/or firmware, different rules may be applied. As such, a first rule of the rule system 308 is associated with the first subset 202a and a second rule of the rule system 308 is associated with the second subset 202b.

A change to a computing system 204 of either subset 202a, 202b may result in a different number of computing systems being in the first subset and/or second subset 202a, 202b. This different number may not yet be appreciated/recognized by the rule system 308. Therefore, the method 700 comprises, at block 702, providing a scale indicative of the number of computing systems 204 in the first and/or second subsets as a result of the change. The logic operation at block 306 may then establish whether or not the rule system 308 needs to be modified in view of the provided scale and may, where needed, modify the rule system 308.

Some further examples related to the above are now described.

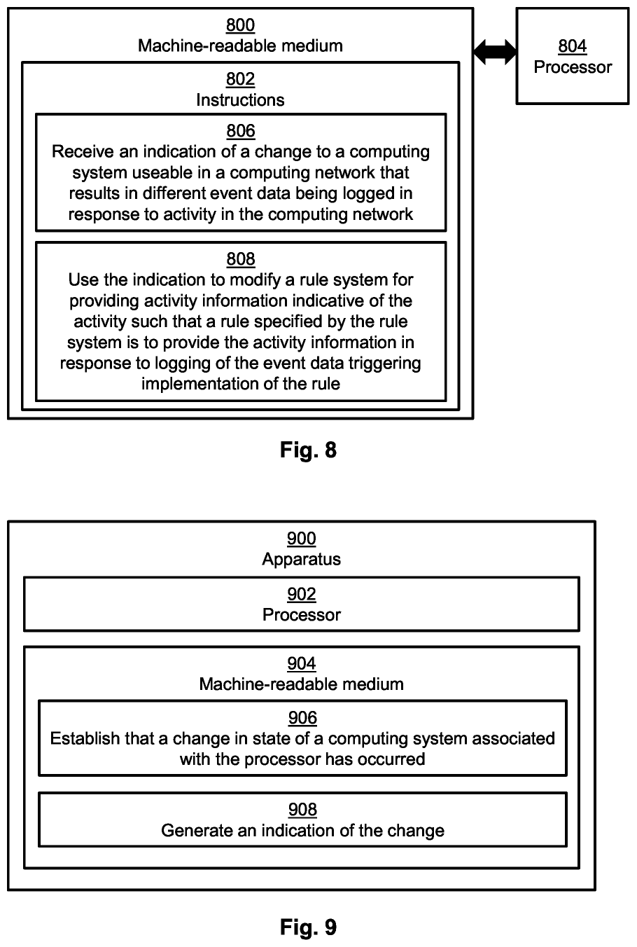

FIG. 8 depicts an example (non-transitory) machine-readable medium 800 for implementing the functionality of certain features described in relation to the architecture 200 such as the logic operation at block 306. In this regard, the machine-readable medium 800 may implement similar or corresponding functionality to the method 100.

The machine-readable medium 800 comprises instructions 802 which, when executed by a processor 804, cause the processor 804 to implement the following instructions.

The instructions 802 comprise instructions 806 to cause the processor 804 to receive an indication of a change to a computing system 204 useable in a computing network that results in different event data being logged in response to activity in the computing network.

The instructions 802 comprise instructions 808 to cause the processor 804 to use the indication to modify a rule system 308 for providing activity information indicative of the activity such that a rule specified by the rule system 308 is to provide the activity information in response to logging of the event data triggering implementation of the rule.

The examples described so far refer to the functionality from the perspective of the analytics side. The following examples refer to the functionality of a computing system 204 itself.

FIG. 9 is a simplified schematic drawing of an example apparatus 900 for use in indicating a change. As explained above, the apparatus 900 may be implemented by the computing system 204 itself.

The apparatus 900 comprises a processor 902. The apparatus 900 further comprises a machine-readable medium 904 (e.g., non-transitory or another type of memory) storing instructions which, when executed by the processor 902, cause the processor 902 to implement the following functionality.

In this regard, the instructions comprise instructions 906 to cause the processor 902 to establish that a change in state of a computing system associated with the processor has occurred. The change in state results in different event data being logged by the processor 902 in response to activity in a computing network associated with the computing system 204.

The instructions comprise further instructions 908 to cause the processor 902 to generate an indication of the change. This may refer to the indication mentioned in relation to the method 100 and other examples. The indication is useable for modifying a rule system 308 for providing activity information indicative of the activity such that a rule specified by the rule system 308 is to provide the activity information in response to the processor 902 logging event data that triggers implementation of the rule.

Thus, in some examples, the apparatus 900 may represent the computing system 204 itself providing the event change log. In other implementations, another entity such as the admin 206 may provide the indication referred to in the method 100 and other examples.

In some examples, the indication comprises a structured file comprising at least one of the following event information.

In some examples, the event information comprises a type of event associated with an event to be logged by the processor 902.

In some examples, the event information comprises a change type indicative of whether the indication relates to a new or existing event to be logged by the processor 902.

In some examples, the event information comprises an event identifier for identifying the event to be logged by the processor 902.

In some examples, the event information comprises an event feature indicative of an attribute of the new or existing event.

In some examples, the event information comprises an event feature value associated with the event feature, where the event feature value is indicative of an attribute value.

In some examples, any number or combination of the event information associated with the above examples may be indicated by the structured file.

Further details of various implementations are described below.

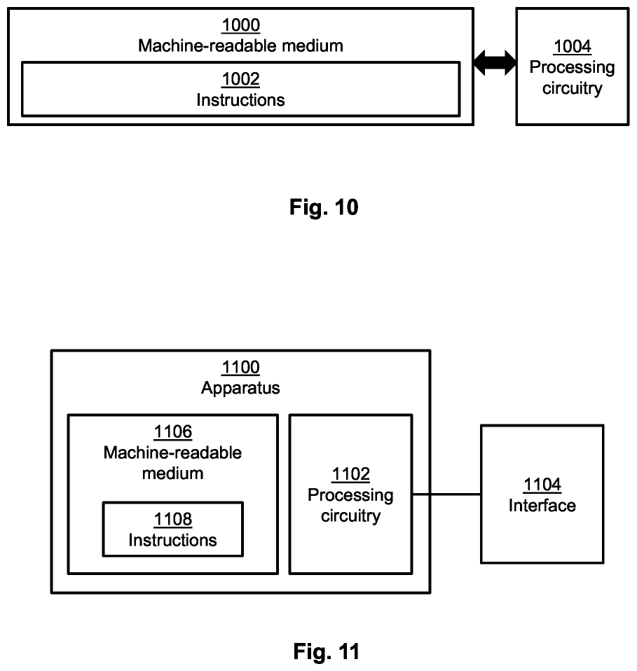

FIG. 10 schematically illustrates an example machine-readable medium 1000 (e.g., a non-transitory machine-readable medium) which stores instructions 1002 which, when executed by processing circuitry 1004 (e.g., a (e.g., at least one) processor), cause the processing circuitry 1004 to carry out certain methods described herein (e.g., method 100, 300, 400, 500, 600, 700), implement other examples relating to the architecture 200 or workflow 300 and/or implement functionality of the machine-readable medium 800 and/or apparatus 900. In other words, any method or functionality implemented by any example described herein may be implemented by the instructions 1002. Thus, with the appropriate instructions, the machine-readable medium 1000 may implement the described functionality of certain entities referred to in FIGS. 2 and 3 (e.g., the computing system 204, admin 206, analytics service 208, parsing operation at block 304, logic operation at block 306 and/or analytic writer at block 316) along with the associated examples.

FIG. 11 is a schematic illustration of an example apparatus 1100 for implementing or at least partially facilitating certain methods or machine-readable media described herein (e.g., certain blocks of methods 100, 300, 400, 500, 600, 700 certain instructions of machine-readable medium 800, certain instructions of apparatus 900 and/or certain functionality of the architecture 200, workflow 300, etc.). The apparatus 1100 comprises processing circuitry 1102 communicatively coupled to an interface 1104 (e.g., implemented by a communication interface) for communicating with other entities referred to in FIGS. 2 and 3 (e.g., if the apparatus 1100 is implemented by the analytics service 208, the interface 1104 may receive data (e.g., logs and other indications such as the event change log) associated with the computing network). The apparatus 1100 further comprises a machine-readable medium 1106 storing instructions 1108, which the apparatus 1100 may use to implement, by execution of the instructions 1108 by the processing circuitry 1102, the described functionality of certain entities referred to in FIGS. 2 and 3 (e.g., the computing system 204, admin 206, analytics service 208, parsing operation at block 304, logic operation at block 306 and/or analytic writer at block 316) along with the associated examples.

Any of the blocks, nodes, instructions or modules described in relation to the figures may be combined with, implement the functionality of or replace any of the blocks, nodes, instructions or modules described in relation to any other of the figures. For example, methods may be implemented as machine-readable media or apparatus, machine-readable media may be implemented as methods or apparatus, and apparatus may be implemented as machine-readable media or methods. Further, any of the functionality described in relation to any one of a method, machine readable medium or apparatus described herein may be implemented in any other one of the method, machine readable medium or apparatus described herein. Any claims written in single dependent form may be re-written, where appropriate, in multiple dependency form since the various examples described herein may be combined with each other.

Examples in the present disclosure can be provided as methods, systems or as a combination of machine-readable instructions and processing circuitry. Such machine-readable instructions may be included on a non-transitory machine (for example, computer) readable storage medium (including but not limited to disc storage, CD-ROM, optical storage, flash storage, etc.) having computer readable program codes therein or thereon.

The present disclosure is described with reference to flow charts and block diagrams of the method, devices and systems according to examples of the present disclosure. Although the flow charts described above show a specific order of execution, the order of execution may differ from that which is depicted. Blocks described in relation to one flow chart may be combined with those of another flow chart. It shall be understood that each block in the flow charts and/or block diagrams, as well as combinations of the blocks in the flow charts and/or block diagrams can be realized by machine readable instructions.

The machine-readable instructions may, for example, be executed by a general-purpose computer, a special purpose computer, an embedded processor or processors of other programmable data processing devices to realize the functions described in the description and diagrams. In particular, a processor or processing circuitry, or a module thereof, may execute the machine-readable instructions. Thus, functional nodes, modules or apparatus of the system and other devices may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate array etc. The methods and functional modules may all be performed by a single processor or divided amongst several processors.

Such machine-readable instructions may also be stored in a computer readable storage that can guide the computer or other programmable data processing devices to operate in a specific mode.

Such machine readable instructions may also be loaded onto a computer or other programmable data processing devices, so that the computer or other programmable data processing devices perform a series of operations to produce computer-implemented processing, thus the instructions executed on the computer or other programmable devices realize functions specified by block(s) in the flow charts and/or in the block diagrams.

Further, the teachings herein may be implemented in the form of a computer program product, the computer program product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the scope of the present disclosure. It is intended, therefore, that the method, apparatus and related aspects be limited by the scope of the following claims and their equivalents. It should be noted that the above-mentioned examples illustrate rather than limit what is described herein, and that many implementations may be designed without departing from the scope of the appended claims. Features described in relation to one example may be combined with features of another example.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A method, comprising:
receiving an indication of a change to a computing system useable in a computing network;
establishing, using processing circuitry, whether a rule system is affected by the change, where the rule system is used to provide activity information indicative of an activity in the computing network, where a rule of the rule system is applied to provide the activity information in response to identification of an event in the computing network that triggers implementation of the rule to provide the activity information; and
in response to establishing that the rule system is affected by the change, causing the rule system to be modified to account for the change.

2. The method of claim 1, comprising:
receiving a log comprising event information about the event; and
in response to the rule being implemented as a result of analysis of the event information, providing the activity information in accordance with the rule system.

3. The method of claim 2, where:
the log is generated by the computing system;
a first rule of the rule system applies to logs generated by a first version of the computing system;
a second rule of the rule system applies to logs generated by a second version of the computing system, the method comprising:
analyzing the event information in the received log to determine whether the first rule or second rule applies; and
implementing the first rule or second rule that is determined to apply to the log generated by the computing system.

4. The method of claim 1, comprising:
in response to establishing that the rule system is affected by the change, indicating a rule template or existing rule for use in creating a new or modified rule for the rule system; and
using the rule template or existing rule to create the new or modified rule based on the indication of the change such that the rule system is modified to account for the change.

5. The method of claim 4, where using the rule template or existing rule to create the new or modified rule based on the indication of the change such that the rule system is modified to account for the change comprises at least one of:
adding event information to the rule template about a new event associated with the change to create the new rule;
modifying the rule template to account for the change;
modifying the existing rule by removing event information about an existing event specified by the existing rule;
modifying the existing rule by replacing event information about an existing event specified by the existing rule with new information about the existing event; and/or
modifying the existing rule by dividing event information about an existing event specified by the existing rule into a plurality of parts of event information.

6. The method of claim 5, where the added, removed, replaced and/or divided event information about the new or existing event comprises at least one of:
a type of the new or existing event;
a change type indicative of whether the indication relates to the new or existing event;
an event identifier for identifying the new or existing event;
an event feature indicative of an attribute of the new or existing event; and/or
an event feature value associated with the event feature, where the event feature value is indicative of an attribute value.

7. The method of claim 1, where causing the rule system to be modified to account for the change comprises changing the activity information to be provided in response to the event based on the received indication.

8. The method of claim 1, where the indication of the change comprises event change data produced by the computing system.

9. The method of claim 8, where the event change data is produced in response to a change in state of the computing system.

10. The method of claim 9, where the change in state comprises at least one of:
execution of an update to a firmware or software operated by the computing system; and/or
a change in hardware of the computing system.

11. The method of claim 1, comprising:
parsing the received indication;
interpreting the parsed indication to identify event change data indicative of a change to how data associated with the activity is logged as a result of the change in the computing network;
establishing whether the rule system is affected by the change based on a comparison of the event change data with the rule system; and
in response to establishing that an existing rule of the rule system is affected by the change, modifying the rule system by causing existing event information in rule content of the rule system to be removed, replaced with new event information or divided into smaller portions of event information based on the event change data; or
in response to establishing that the rule system does not take into account the change, modifying the rule system by causing new event information to be added to rule content of the rule system based on the event change data.

12. The method of claim 1, where:
the computing network comprises a set of computing systems;
a first subset of the set of computing systems comprises a first version of hardware, software and/or firmware;
a second subset of the set of computing systems comprises a second version of hardware, software and/or firmware;
a first rule of the rule system is associated with the first subset;
a second rule of the rule system is associated with the second subset;
the change to the computing system results in a different number of computing systems being in the first subset and/or second subset, the method comprising:
providing a scale indicative of the number of computing systems in the first and/or second subsets as a result of the change.

13. A non-transitory machine-readable medium storing instructions which, when executed by a processor, cause the processor to:
receive an indication of a change to a computing system useable in a computing network that results in different event data being logged in response to activity in the computing network; and
use the indication to modify a rule system for providing activity information indicative of the activity such that a rule specified by the rule system is to provide the activity information in response to logging of the event data triggering implementation of the rule.

14. Apparatus comprising:
a processor; and
a machine-readable medium storing instructions which, when executed by the processor, cause the processor to:
establish that a change in state of a computing system associated with the processor has occurred, where the change in state results in different event data being logged by the processor in response to activity in a computing network associated with the computing system; and
generate an indication of the change, where the indication is useable for modifying a rule system for providing activity information indicative of the activity such that a rule specified by the rule system is to provide the activity information in response to the processor logging event data that triggers implementation of the rule.

15. The apparatus of claim 14, where the indication comprises a structured file comprising at least one of:
a type of event associated with an event to be logged by the processor;
a change type indicative of whether the indication relates to a new or existing event to be logged by the processor;
an event identifier for identifying the event to be logged by the processor;
an event feature indicative of an attribute of the new or existing event; and/or
an event feature value associated with the event feature, where the event feature value is indicative of an attribute value.
